(19) United States
(12) Patent Application Publication
(10) Pub. No.: US 2010/0318814 A1
(43) Pub. Date: Dec. 16, 2010

(54) POWER MANAGEMENT DEVICE AND POINT OF SALES TERMINAL APPARATUS USING THEREOF

(75) Inventors: Yann-Lang Chung, Taoyuan (TW); Liang-An Chen, Taipei County (TW); Kuo-Chan Hsu, Taoyuan (TW); Ming-Yen Shen, Taipei City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/482,408

(22) Filed: Jun. 10, 2009

(51) Int. Cl. G06F 1/26

(52) U.S. Cl. 713/300

(57) ABSTRACT

A point of sales (POS) terminal apparatus including a POS device, a peripheral device, which is controlled by the POS device, an adapter, and a power management device is provided. The adapter provides a first power signal based on a wall-outlet power signal. The power management device provides the first power signal to drive the POS device and determines whether the first power signal satisfies a predetermined condition. When the first power signal fails to satisfy the predetermined condition, the power management device generates a second power signal and drives the peripheral device with the second power signal. When the first power signal satisfies the predetermined condition, the power management device drives the peripheral device with the first power signal.

### BACKGROUND OF THE INVENTION

1. Field of the Invention

The invention relates in general to a power management device, and more particularly to a power management device applied in a point of sales (POS) terminal apparatus of a POS system.

2. Description of the Related Art

Point of sales (POS) systems have been widely used in applications, e.g. department stores or supermarkets which handle a variety of goods on a vary large scale, for managing the sales and stock data of such goods. Conventionally, the POS system includes a host apparatus and a number of POS terminal apparatuses, each of which includes a number of user input/output (I/O) interface devices for the clerical employees to handle financial transactions. In general, those user I/O interface devices include a keyboard, a display, a cash drawer, and a printer.

Conventionally, a great number of adapters are needed to properly drive the respective user I/O interface devices employed in the POS terminal apparatuses. However, the conventional POS system disadvantageously leads to higher cost and larger occupation area.

### SUMMARY OF THE INVENTION

The invention is directed to a power management device applied in a point of sales (POS) terminal apparatus, which includes a POS device, a peripheral device, and an adapter, capable of driving both the POS device and the peripheral device with a power signal provided by the adapter. Thus, in comparison to the conventional POS terminal apparatus, the power management device can effectively reduce the cost and the occupation area for the POS terminal apparatus employing the power management device directed to by the invention.

According to a first aspect of the present invention, a POS terminal apparatus is provided. The POS terminal apparatus includes a POS device, a peripheral device, which is controlled by the POS device, an adapter, and a power management device. The adapter provides a first power signal based on a wall-outlet power signal. The power management device provides the first power signal to drive the POS device and determines whether the first power signal satisfies a predetermined condition. When the first power signal fails to satisfy the predetermined condition, the power management device generates a second power signal and drives the peripheral device with the second power signal. When the first power signal satisfies the predetermined condition, the power management device drives the peripheral device with the first power signal.

According to a second aspect of the present invention, a power management device applied in a POS terminal apparatus, which includes a POS device and a peripheral device is provided. The power management device drives the POS device and the peripheral device based on a first power signal. The power management device includes a voltage boost unit and a current sense unit. The voltage boost unit is controlled by a feedback signal to generate a second power signal based on the first power signal. The current sense unit senses a current loading of the first power signal and determines whether the current loading of the first power signal is greater than a set value and accordingly providing the feedback signal to the voltage boost unit. When the current loading of the first power signal is not greater than the set value, the current sense unit enables the feedback signal to drive the voltage boost unit generating the second power signal, and the voltage boost unit drives the peripheral device with the second power signal. When the current loading of the first power signal is greater than the set value, the current sense unit disables the control signal, and the voltage boost unit drives the peripheral device with the first power signal. The current sense unit further drives the POS device with the first power signal.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of the POS terminal apparatus according to the embodiment of the invention.

FIG. 2 is a detailed block diagram of the power management device according to the embodiment of the invention.

FIG. 3 is a detailed block diagram of the voltage boost unit according to the embodiment of the invention.

FIG. 4 is a detailed block diagram of the current sense unit according to the present embodiment of the invention.

### DETAILED DESCRIPTION OF THE INVENTION

The power management device according to the present embodiment of the invention drives a point of sales (POS) device and a peripheral device with a power signal provided by an adapter.

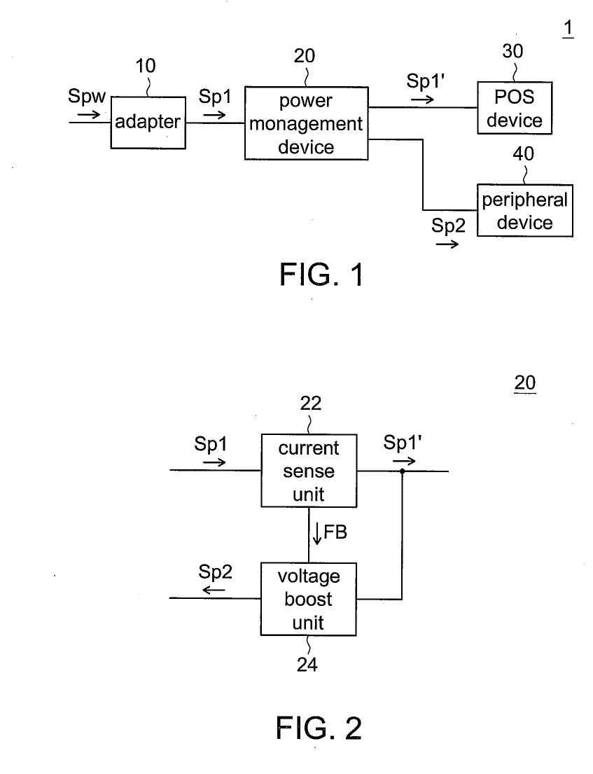

Referring to FIG. 1, a block diagram of the POS terminal apparatus according to the embodiment of the invention is shown. The POS terminal apparatus 1 is employed in a POS system (not shown), which further employs a host apparatus (not shown) for communicating with the host apparatus. The POS terminal apparatus 1 includes a POS device 30, a peripheral device 40, an adapter 10, and a power management device 20. The adapter 10 provides a power signal Sp1 based on a wall-outlet power signal Spw.

In an embodiment, the peripheral device 40 is a device demanding a power supply signal with high circuit drivability and capable of working while the voltage level of the power supply signal is unstable. For example, the peripheral device 40 is a printer, which can operate, with the lowered printing speed when the voltage level of the power supply signal drops significantly.

The power management device 20 provides a power signal Sp1′, which is substantially the same as the power signal Sp1, to drive the POS device 30. The power management device 20 further determines whether the power signal Sp1 satisfies a predetermined condition. In an embodiment, the predetermined condition corresponds to whether the peripheral device 40 is driven to operate and occupies a great amount of drivability of the power signal Sp1. When the power signal Sp1 fails to satisfy the predetermined condition (i.e. the peripheral device 40 is not driven to operate), the power management device 20 generates a power signal Sp2 and drives the peripheral device 40 with the power signal Sp2. For example, the power signal Sp2 corresponds to a specifications-defined supply voltage level, which is substantially higher than that of the power signal Sp1, for the peripheral device 40.

When the power signal Sp1 satisfies the predetermined condition (i.e. the peripheral device 40 is driven to operate), the power management device 20 stops generating the power signal Sp2 and drives the peripheral device 40 with the power signal Sp1′, which corresponds to substantially the same voltage level as the power signal Sp1. Thus, the loading for the adapter 10 is lowered when the peripheral device 40 is driven to operate. In other words, the power management device 20 drives both the POS device 30 and the peripheral device 40 with one power signal and prevent the adapter 10 facing the overcurrent situation by means of selectively lowering the voltage level of the power signal driving the peripheral device 40 at the same time.

Referring to FIG. 2, a detailed block diagram of the power management device 20 according to the embodiment of the invention is shown. For example, the power management device 20 includes a current sense unit 22 and a voltage boost unit 24. The voltage boost unit 24 is controlled by a feedback signal FB to generate the power signal Sp2 based on the power signal Sp1′.

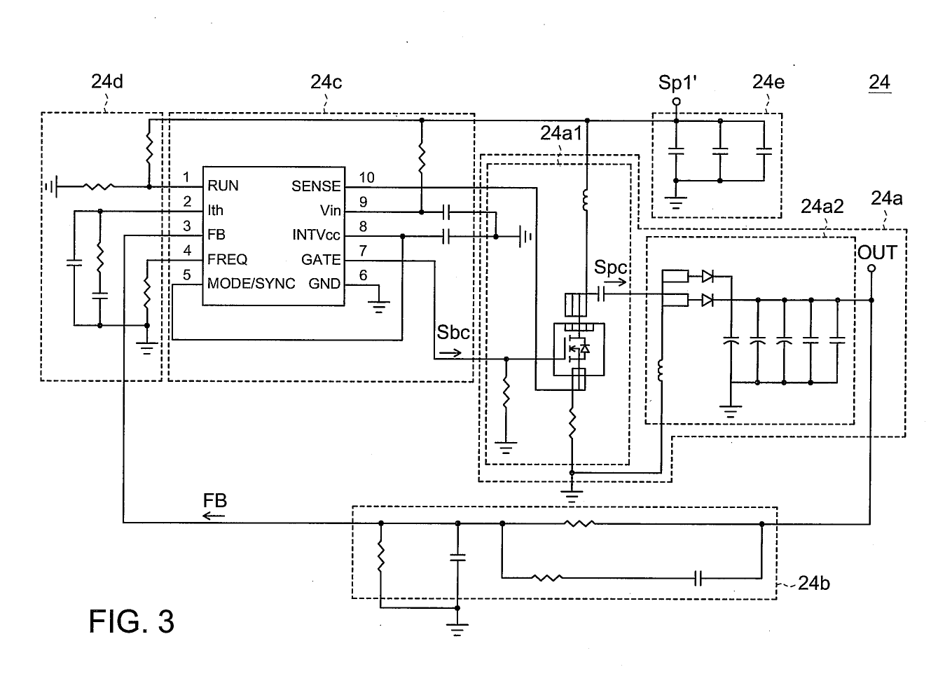

Referring to FIG. 3, a detailed block diagram of the voltage boost unit according to the embodiment of the invention is shown. For example, the voltage boost unit 24 includes a voltage converter 24a, a feedback circuit 24b, and a boost controller 24c. In an embodiment, the boost controller 24c is implemented with an integrated circuit (IC) LTC1871, which includes pins #1 to #10. For example, the pin #9 receives the power signal Sp1′, the pin #3 receives the feedback signal FB, and the pin #7 provides a boot control signal Sbc. For example, the boost control signal Sbc is a pulse width modulation (PWM) signal. When the boost controller 24c is powered, the boost controller 24c controls the operation of the voltage converter 24a by means of manipulating the boot control signal Sbc in response to the feedback signal FB.

In an embodiment, the voltage converter 24a includes an output end OUT and converter units 24a1 and 24a2. The output end OUT is for providing a power signal (the power signal Sp1′ or Sp2) to the peripheral device 40. The converter unit 24a1 is, for example, a single-ended primary inductance converter (SEPIC), for converting the power signal Sp1′ in response to the boost control signal Sbc, so as to provide a converted power signal Spc. The converter unit 24a2 is, for example, a flyback converter, for generating the power signal Sp2 according the converted power signal Spc and providing the power signal Sp2 to the output end OUT. For example, the voltage level of the power signal Sp1 (=that of the power signal Sp1′) is equal to 19 Volts (V) and the power signal Sp2 corresponds to the 24 Volts (V).

The feedback circuit 24b receives a signal on the output end OUT (the power signal Sp2 for example) and accordingly generates the feedback signal FB. The feedback circuit 24b provides the feedback signal FB to the pin #3 of the IC LTC1871, so as to drive the IC LTC1871 provides the boost control signal Spc. Thus, the voltage converter 24a is controlled by the feedback signal FB to generate the power signal Sp2 based on the power signal Sp1′.

In an embodiment, an auxiliary circuit 24d is employed for providing signal settings to the pins #1, #2, and #4, so as to enable the IC LTC1871. For example, the auxiliary circuit 24d includes a voltage divider for providing a run signal to the pin #1, an error amplifier for compensation of the signal provided to the pin #2, and a biasing resistor biasing the signal provided to the pin #4 for programming the operating frequency of the IC LTC1871. For example, the voltage level of the run signal is equal 1.248V and the voltage level of the signal provided to the pin #4 is equal to 0.6V.

In other embodiment, an auxiliary circuit 24e is employed for stabilizing the voltage level of the power signal Sp1′. For example, the auxiliary circuit 24e includes a filter for reducing the voltage ripple of the power signal Sp1′.

The current sense unit 22 senses a current loading signal Sil of the power signal Sp1. The current sense unit 22 further determines whether the peripheral device 40 is driven to operate and occupies a great amount of drivability of the power signal Sp1 by means of determining whether the current loading signal Sil is greater than a set value. The current sense unit 22 further manipulates the feedback signal FB based on the determined result of whether the current loading signal Sil is greater than the set value, so as to control the operation of the voltage boost unit 24.

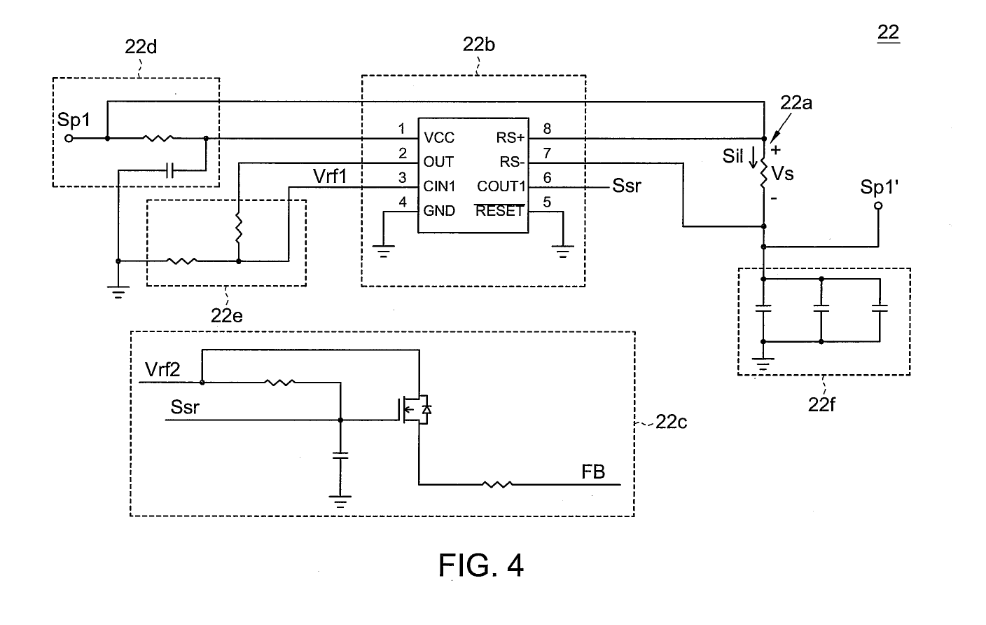

Referring to FIG. 4, a detailed block diagram of the current sense unit according to the present embodiment of the invention is shown. For example, the current sense unit 22 includes a sense resistor 22a, a comparator 22b, and a switch 22c. The sense resistor 22a generates a sense voltage Vs, which corresponds to the magnitude of the current loading signal Sil, based on the current loading signal Sil.

In an embodiment, the comparator 22b is implemented with an available IC MAX4373, which includes pins #1 to #8. For example, the pin #1 receives the power signal Sp1, the pin #3 receives a reference voltage Vrf1, the pins #7 and #8 receive the sense voltage Vs, and the pin #6 provides a sense result signal Ssr. When the comparator 22b is powered, the comparator 22b generates the sense result signal Ssr by comparing the level of the voltage signal Vs and the reference voltage signal Vrf1. For example, the threshold voltage Vrf1 corresponds to the set value of the current loading signal Sil.

When the voltage signal Vs is smaller than the threshold voltage Vrf1, the comparator 22b provides the sense result signal Ssr indicating the current loading signal Sil is not greater than the set value. When the voltage signal Vs is greater than the threshold voltage Vrf1, the comparator 22b provides the sense result signal Ssr indicating the current loading signal Sil is greater than the set value.

The switch 22c controls the level of the feedback signal FB in response to the sense result signal Ssr. For example, the switch 22c is turned on for biasing the feedback signal FB with a second reference voltage Vrf2 in response to the sense result signal Ssr indicating the current loading signal Sil is greater than the set value. In response to the feedback signal FB biased by the reference voltage Vrf2, the boost controller 24c disables the boost control signal Sbc, such that the voltage converter 24a is disabled from generating the power signal Sp2 and the converter units 24a1 and 24a2 provides a short path for providing the power signal Sp1′ to the output end OUT. Thus, the voltage boost unit 24 drives the peripheral device 40 with the power signal Sp1′ corresponding the substantially the same voltage level as the power signal Sp1 on the output end OUT.

The switch 22c is turned off in response to the sense result signal Ssr indicating the current loading signal Sil is not greater than the set value, such that the feedback signal FB is not biased by the reference voltage Vrf2. In response to the feedback signal FB not biased by the reference voltage Vrf2, the boost controller 24c keeps enabling the boost control signal Sbc, such that the voltage converter 24a is enabled to generate the power signal Sp2 and drive the peripheral device 40 with the power signal Sp2.

In an embodiment, a delay circuit (not shown) is implemented in the IC LTC1871 for delaying the operation carried out by the boost controller 24c of providing the boost control signal Sbc in response to the feedback signal by a time delay. Thus, the boost controller 24c can effectively disable the voltage converter 24a after the current loading signal Sil became greater than the set value for the time delay.

In other embodiment, an auxiliary circuit 22d is employed for protecting the IC MAX4373 from being damaged by the transient voltage of the power signal Sp1. For example, the auxiliary circuit 22d includes a bypass circuit for preventing the transient voltage of the power signal Sp1 entering the IC MAX4373. In other embodiment, an auxiliary circuit 22e is employed for providing signal settings to the pins #2 and #3 related to the reference voltage Vrf1. For example, the auxiliary circuit 22e includes a voltage divider for providing the reference signal Vrf1 to the pin #3 of the IC MX4373 according to a reference signal provided by the pin #2 of the IC MAX4373. In other embodiment, an auxiliary circuit 22f is used for stabilizing the power signal Sp1′. For example, the auxiliary circuit 22f includes a filter for reducing the voltage ripple of the power signal Sp1′.

Though only the cases that the boost controller 24c and the comparator 22b are respectively implemented with available ICs LTC1871 and MAX4373 are cited as examples disclosed above, the boost controller 24c and the comparator 22b are not limited thereto. Though only the case that the voltage converter 24a includes a SEPIC and a flyback converter is cited as an example disclosed above, the voltage converter 24a is not limited thereto.

The power management device according to the present embodiment of the invention drives a POS device and a peripheral device included in a POS terminal apparatus with a power signal provided by an adapter. Thus, in comparison to the conventional POS terminal apparatus, the power management device according to the present embodiment of the invention can effectively reduce the number of adapters needed to drive the POS terminal apparatus. Consequently, the cost and the occupation area for the POS terminal apparatus employing the power management device directed to by the invention can also be reduced.

Besides, the power management device according to the present embodiment of the invention employs a current sense unit for sensing a current loading of the power signal provided by the adapter and a voltage boost unit for selectively providing a power signal with boosted voltage level based on a sense result related to the magnitude of the current loading. Thus, the power management device according to the present embodiment of the invention can prevent the power signal driving the POS device in the POS terminal apparatus from being unstable due to the current overload caused by the share of the power signal between the POS device and the peripheral device and prevent the POS device from going down due to the unstable power signal.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A point of sales (POS) terminal apparatus, comprising:
a POS device;
a peripheral device, controlled by the POS device;
an adapter, for providing a first power signal based on a wall-outlet power signal; and
a power management device, providing the first power signal to drive the POS device, the power management device further determining whether the first power signal satisfies a predetermined condition, wherein:
when the first power signal fails to satisfy the predetermined condition, the power management device generates a second power signal and drives the peripheral device with the second power signal; and
when the first power signal satisfies the predetermined condition, the power management device drives the peripheral device with the first power signal.

2. The POS terminal apparatus according to claim 1, wherein the power management device comprises:
a voltage boost unit, controlled by a feedback signal, to generate the second power signal based on the first power signal; and
a current sense unit, for sensing a current loading of the first power signal, the current sense unit further determining whether the current loading of the first power signal is greater than a set value to accordingly determine whether the first power signal satisfies the predetermined condition, the current sense unit further manipulating the feedback signal to control the voltage boost unit.

3. The POS terminal apparatus according to claim 2, wherein when the current loading of the first power signal is not greater than the set value, the current sense unit enables the feedback signal to drive the voltage boost unit generating the second power signal, and the voltage boost unit drives the peripheral device with the second power signal.

4. The POS terminal apparatus according to claim 2, wherein when the current loading of the first power signal is greater than the set value, the current sense unit disables the feedback signal to disable the voltage boost unit from generating the second power signal, and the voltage boost unit drives the peripheral device with the first power signal.

5. The POS terminal apparatus according to claim 2, wherein the current sense unit comprises:
a sense resistor, for generating a sense voltage based on the current loading of the first power signal, the sense voltage corresponding to the magnitude of the current loading;
a comparator, for comparing the sense voltage and a first reference voltage and accordingly providing a sense result signal indicating whether the current loading of the first power signal is greater than the set value; and
a switch, turned on for biasing the feedback signal with a second reference voltage in response to the sense result signal indicating the current loading of the first power signal is greater than the set value and turned off in response to the sense result signal indicating the current loading of the first power signal is not greater than the set value.

6. The POS terminal apparatus according to claim 5, wherein the voltage boost unit comprises:
a voltage converter, controlled by a boost control signal, generating the second power signal based on the first power signal;
a feedback circuit, generating the feedback signal based on the second power signal; and
a boost controller, enabling the boost control signal to drive the voltage converter generating the second power signal in response to the feedback signal not biased by the second reference voltage, the boost controller disabling the boost control signal from driving the voltage converter generating the second power signal in response to the feedback signal biased by the second reference voltage.

7. The POS terminal apparatus according to claim 6, wherein the voltage boost unit further comprises:
a delay circuit, for delaying the operation of providing the boost control signal carried out by the boost controller in response to the feedback signal by a time delay.

8. The POS terminal apparatus according to claim 2, wherein the second power signal corresponds to a signal level higher than that corresponding to the first power signal.

9. The POS terminal apparatus according to claim 1, wherein the peripheral device is a device demanding a power supply signal with high circuit drivability and capable of working while a voltage level of the power supply voltage is unstable.

10. A power management device, applied in a point of sales (POS) terminal apparatus, which comprises a POS device and a peripheral device, the power management device driving the POS device and the peripheral device based on a first power signal, the power management device comprising:
a voltage boost unit, controlled by a feedback signal, to generate a second power signal based on the first power signal; and
a current sense unit, for sensing a current loading of the first power signal, determining whether the current loading of the first power signal is greater than a set value and accordingly providing the feedback signal to the voltage boost unit, wherein:
when the current loading of the first power signal is not greater than the set value, the current sense unit enables the feedback signal to drive the voltage boost unit generating the second power signal, and the voltage boost unit drives the peripheral device with the second power signal;
when the current loading of the first power signal is greater than the set value, the current sense unit disables the control signal, and the voltage boost unit drives the peripheral device with the first power signal; and
the current sense unit further drives the POS device with the first power signal.

11. The power management device according to claim 10, wherein the current sense unit comprises:
a sense resistor, for generating a sense voltage based on the current loading of the first power signal, the sense voltage corresponding to the magnitude of the current loading;
a comparator, for comparing the sense voltage and a first reference voltage and accordingly providing a sense result signal indicating whether the current loading of the first power signal is greater than the set value; and
a switch, turned on for biasing the feedback signal with a second reference voltage in response to the sense result signal indicating the current loading of the first power signal is greater than the set value and turned off in response to the sense result signal indicating the current loading of the first power signal is not greater than the set value.

12. The power management device according to claim 11, wherein the voltage boost unit comprises:
a voltage converter, controlled by a boost control signal, generating the second power signal based on the first power signal;
a feedback circuit, generating the feedback signal based on the second power signal; and
a boost controller, enabling the boost control signal to drive the voltage converter generating the second power signal in response to the feedback signal not biased by the second reference voltage, the boost converter disabling the boost control signal from driving the voltage converter generating the second power signal in response to the feedback signal biased by the second reference voltage.

13. The power management device according to claim 12, wherein the voltage boost unit further comprises:
a delay circuit, for delaying the operation of providing the boost control signal carried out by the boost controller in response to the feedback signal by a time delay.

14. The power management device according to claim 10, wherein the second power signal corresponds to a signal level higher than that corresponding to the first power signal.
